(19) United States
(12) Patent Application Publication
(10) Pub. No.: US 2006/0207444 A1
(43) Pub. Date: Sep. 21, 2006

(54) Automotive leather cutting station

(76) Inventor: Nicolaas Schneider, Visagiepark (ZA)

Correspondence Address: THE WEBB LAW FIRM, P.C., 700 KOPPERS BUILDING, 436 SEVENTH AVENUE, PITTSBURGH, PA, 15219, US

(21) Appl. No.: 11/364,844

(22) Filed: Feb. 28, 2006

(30) Foreign Application Priority Data
Mar. 3, 2005 (ZA) 2005/01844

(51) Int. Cl. A47J 17/00

(52) U.S. Cl. 99/537

(57) ABSTRACT

A sheet material cutting table includes a base comprising a foot component and a turntable component and a table top rotatably supported on the base to rotate about a generally vertical axis. The table top includes a support formation and a planar top component defining a planar work surface. At least one of the base and the table top has a track and at least one of the other of the base and the table top has rolling elements configured to roll along the track thereby allowing the table top to be linearly displaceable in a horizontal plane relative to the base.

### BACKGROUND OF THE INVENTION

1. Field of the Invention

The present invention relates, in general, to the cutting of a sheet material and, more particularly, to a sheet material cutting table and a sheet material cutting station.

2. Description of Related Art

Conventional systems for cutting large pieces of sheet material often require large tables for stretching and positioning the sheet material. Cutting dies are then manually placed on the sheet material. This requires a worker to walk around the table and place the cutting dies in appropriate positions. Furthermore, the worker has to consistently return to a location of a tool rack to obtain additional cutting dies for placement on the sheet material.

Therefore, the cutting of large pieces of sheet material, such as hides or the like, is often a labor intensive process requiring large working areas.

Accordingly, a need exists for a sheet material cutting device that would provide a savings in time and space thereby improving the efficiency and thus the economics of the cutting process.

### SUMMARY OF THE INVENTION

The present invention is directed to a sheet material cutting table. The table includes a base comprising a foot component and a turntable component and a table top rotatably supported on the base to rotate about a generally vertical axis. The table top includes a support formation and a planar top component defining a planar work surface. At least one of the base and the table top has a track and at least one of the other of the base and the table top has rolling elements configured to roll along the track thereby allowing the table top to be linearly displaceable in a horizontal plane relative to the base.

The table top may rotate in both a clockwise and a counter-clockwise direction. The support formation of the table top comprises a frame that is one of circular, polygonal or hexagonal. The frame of the support formation of the table top may include a plurality of rollers rollably supported therein to slidably support the planar top component. The support formation may include friction-reducing elements to assist in sliding the top component onto or off the support formation. The turntable component of the base may be rotatably mounted on the foot component of the base. The sheet material may be leather or automotive leather.

The present invention is also a sheet material cutting station. The sheet material cutting station includes a sheet material cutting table, an overhead support positioned above the sheet material cutting table and a tool rack suspended from the overhead support. The sheet material cutting table includes a base comprising a foot component and a turntable component and a table top rotatably supported on the base to rotate about a generally vertical axis. The table top includes a support formation and a planar top component defining a planar work surface. At least one of the base and the table top has a track and at least one of the other of the base and the table top has rolling elements configured to roll along the track thereby allowing the table top to be linearly displaceable in a horizontal plane relative to the base.

The tool rack may include a plurality of cutting die compartments defined by upwardly projecting pins. The die compartments may be configured to hold a cutting die on its side. The overhead support may be configured to allow displacement of the tool rack in an elevated, horizontal plane, in two perpendicular directions. The overhead support may displace the tool rack over an area that is larger than an area of the sheet material cutting table. The overhead support may allow the tool rack to rotate about a generally vertical axis of rotation. The sheet material cutting station may further comprise an inspection table to inspect cut pieces of sheet material.

The present invention is also a method of cutting a sheet material. The method comprises providing a sheet material cutting table. The sheet material cutting table includes a base comprising a foot component and a turntable component and a table top rotatably supported on the base to rotate about a generally vertical axis. The table top includes a support formation and a planar top component defining a planar work surface. At least one of the base and the table top has a track and at least one of the other of the base and the table top has rolling elements configured to roll along the track thereby allowing the table top to be linearly displaceable in a horizontal plane relative to the base. Next, a piece of sheet material is placed on top of the planar work surface of the planar top component. Then at least one cutting die is removed from a tool rack suspended from an overhead support, the overhead support positioned above the sheet material cutting table and placed on the piece of sheet material. The planar top component is then slidably pulled from the support formation and into a cutting press and the cutting press is pressed down on the at least one cutting die thereby cutting the sheet material.

These and other features and characteristics of the present invention, as well as the methods of operation and functions of the related elements of structures and the combination of parts and economies of manufacture, will become more apparent upon consideration of the following description and the appended claims with reference to the accompanying drawings, all of which form a part of this specification, wherein like reference numerals designate corresponding parts in the various figures. As used in the specification and the claims, the singular form of “a”, “an”, and “the” include plural referents unless the context clearly dictates otherwise.

### BRIEF DESCRIPTION OF THE DRAWINGS

FIG. 1 is an elevational sectional side view of a sheet material cutting table in accordance with the present invention;

FIG. 2 is an exploded elevational sectioned side view of the sheet material cutting table of FIG. 1;

FIG. 3 is a top plan view of the sheet material cutting table of FIG. 1 without a top component;

FIG. 4 is a top plan view of a turntable component of the leather cutting table of FIG. 1;

FIGS. 5-8 are elevational sectional side views of the leather cutting table of FIG. 1, in use;

FIG. 9 is a top plan view of eight sheet material cutting stations in accordance with the present invention;

FIG. 10 is a perspective view of a tool rack of the sheet material cutting stations of FIG. 9; and

FIG. 11 is a perspective view of an inspection table of the sheet material cutting stations of FIG. 9.

### DETAILED DESCRIPTION OF THE INVENTION

For purposes of the description hereinafter, the terms “upper”, “lower”, “right”, “left”, “vertical”, “horizontal”, “top”, “bottom”, “lateral”, “longitudinal” and derivatives thereof shall relate to the invention as it is oriented in the drawing figures. However, it is to be understood that the invention may assume various alternative variations, except where expressly specified to the contrary. It is also to be understood that the specific devices illustrated in the attached drawings, and described in the following specification, are simply exemplary embodiments of the invention. Hence, specific dimensions and other physical characteristics related to the embodiments disclosed herein are not to be considered as limiting.

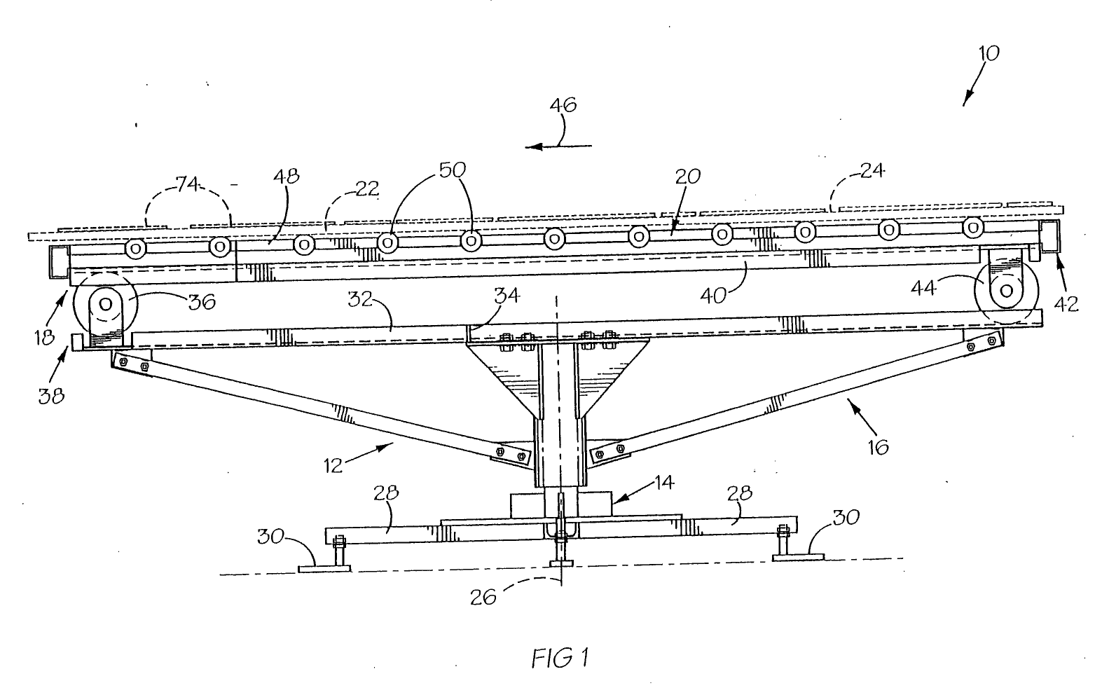

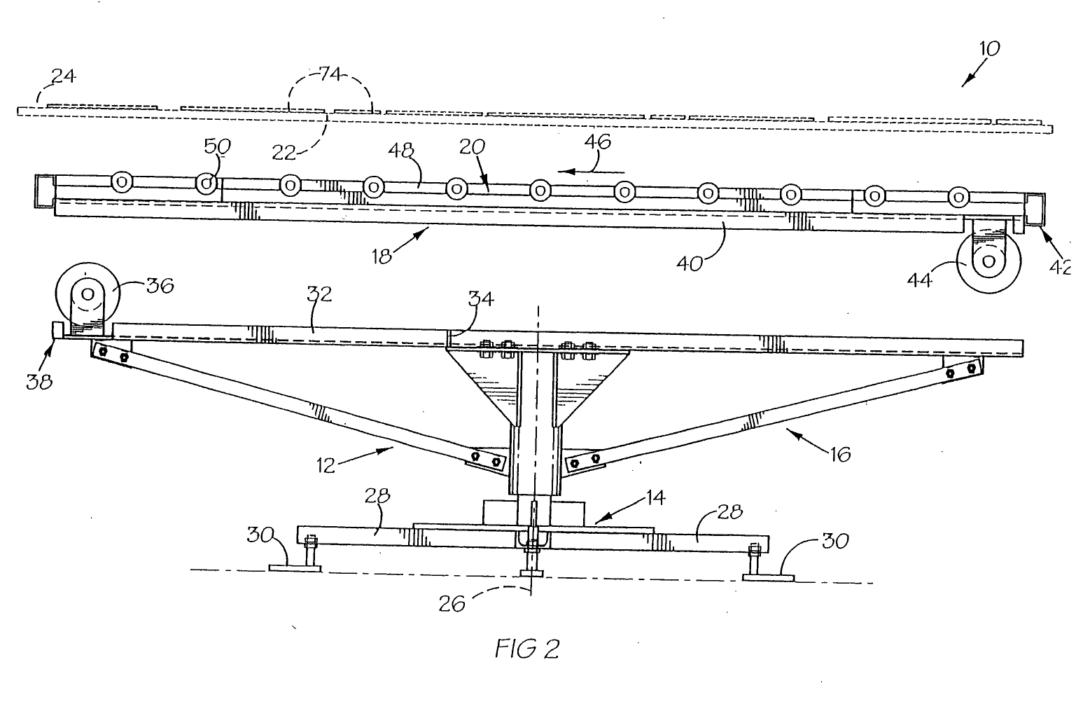

With reference to FIGS. 1 and 2, a sheet material cutting table 10 comprises a base 12 having a foot component 14 and a turntable component 16. The cutting table 10 also includes a table top 18 comprising a support formation 20 and a planar top component 22 defining a planar work surface 24. The turntable component 16 is rotatably mounted on the base 12 such that it rotates about a generally vertical axis of rotation 26. The table top 18 is thus rotatably supported on the base 12 to rotate about the generally vertical axis of rotation 26. The turntable component 16 is freely rotatable by hand in a clockwise and counter-clockwise direction.

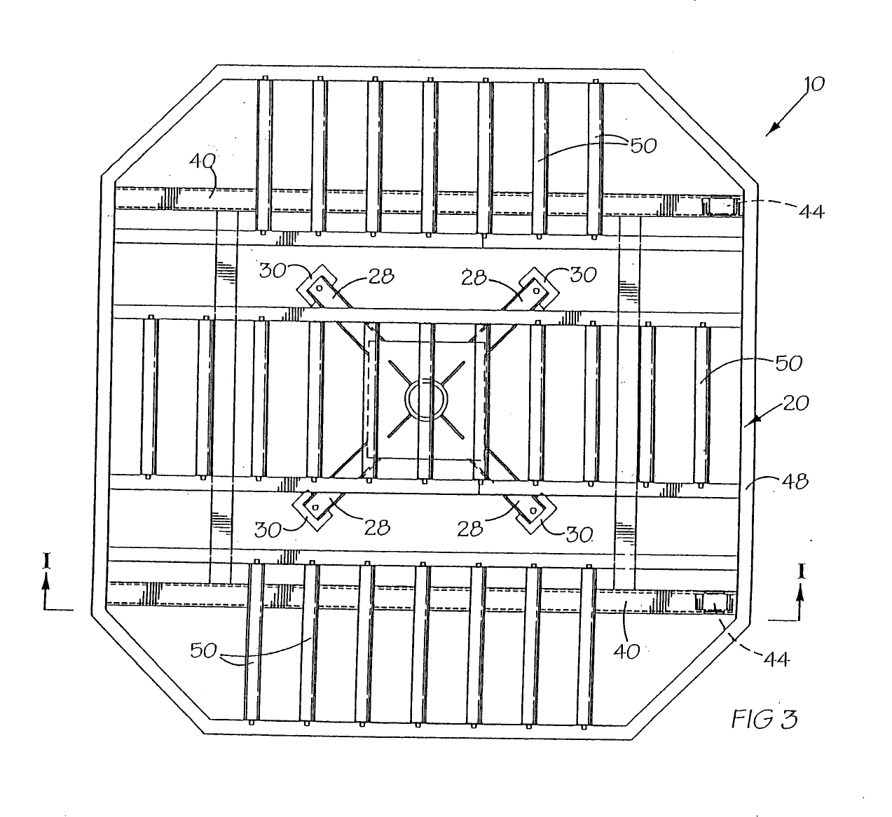

With reference to FIG. 3 and with continuing reference to FIGS. 1 and 2, the foot component 14 includes four legs 28 each ending in a foot 30. The feet 30 may be fastened to a support surface such as the floor.

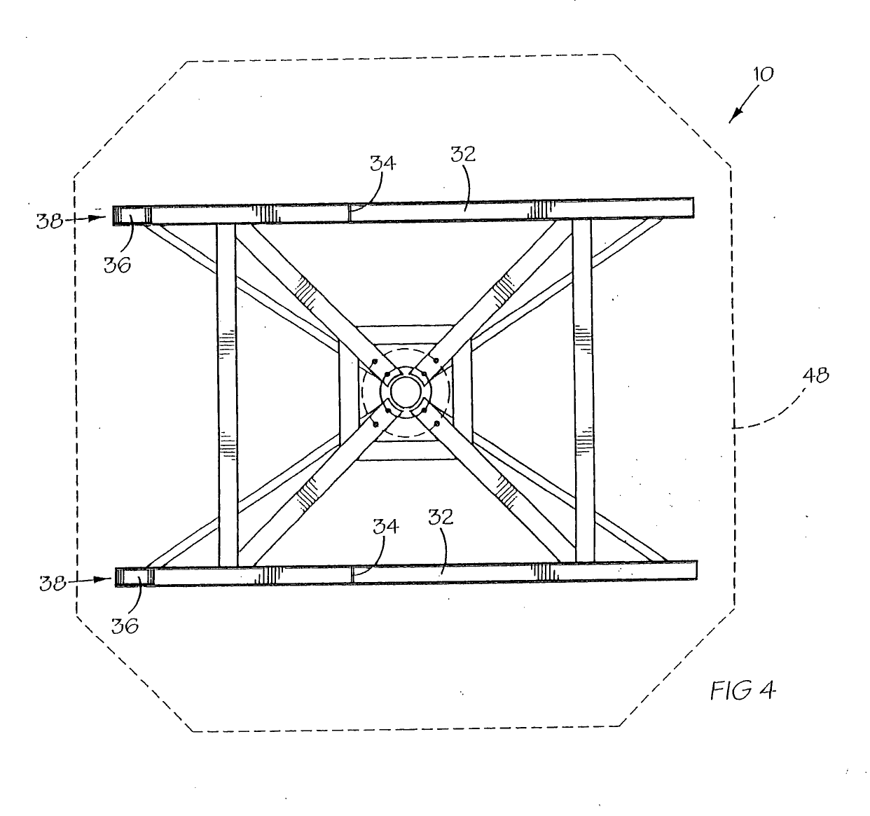

With reference to FIG. 4 and with continuing reference to FIGS. 1-3, the turntable component 16 includes two horizontally spaced parallel U-shaped tracks 32. The tracks 32 are horizontally arranged and each track 32 includes a stop formation 34 blocking the track. A pair of spaced wheels 36 is provided at ends 38 of the tracks 32. The wheels 36 are fixedly mounted to the tracks 32 to project upwardly from the tracks 32.

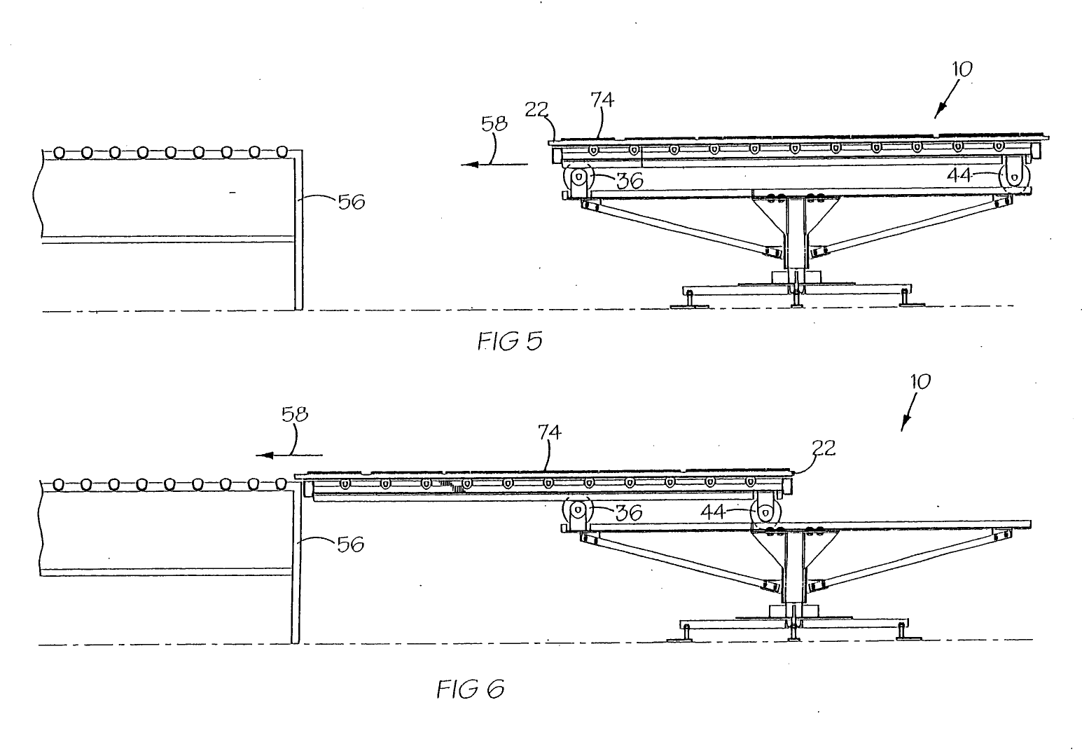

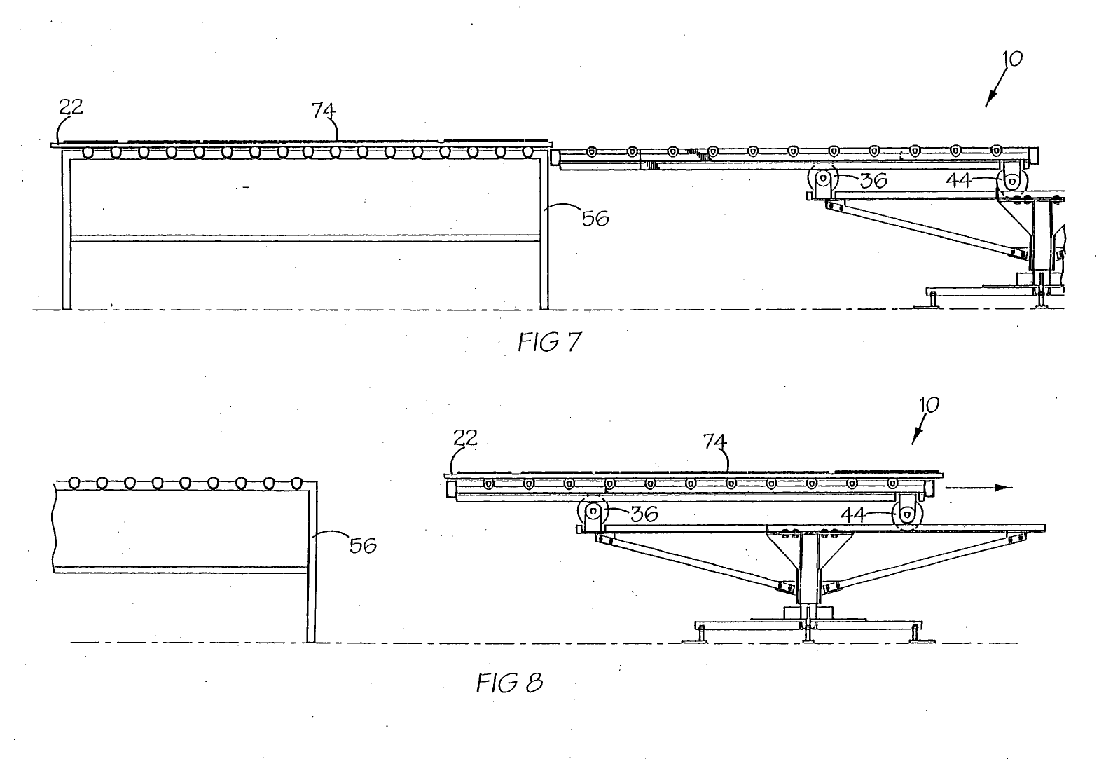

The support formation 20 also includes two tracks 40. The tracks 40 are horizontally spaced and parallel and are in the form of inverted U-shaped channels. The tracks 40 are vertically in register with the tracks 32. One end of each track 40 is supported on one of the wheels 36. At an opposed end 42 of the tracks 40, a pair of wheels 44 is provided, one wheel 44 being associated with each track 40. Each wheel 44 is provided with a hand brake (not shown). The wheels 44 are fixedly mounted to the tracks 40 and project downwardly, resting on the tracks 32. The table top 18 is thus slidable, by means of the tracks 32, 40 and the wheels 36, 44 in the direction of the arrows 46 shown in FIGS. 1 and 2 and back. The table top 18 can slide in the direction of the arrow 46 until the wheels 44 hit the stop formations 34. In this position, the table top 18 is cantilevered relative to the base 12, as shown in FIGS. 6 and 7 of the drawings.

The support formation 20 of the table top 18 includes a frame 48 which may be polygonal, with more than four corners when viewed in plan, and with none of the corners being less than 90°. For instance, the frame 48 may be hexagonal in top plan view, with four longer sides and four shorter sides, the longer sides being connected by the shorter sides such that the longer and shorter sides are alternately arranged. While the frame 48 has been described as being hexagonal in shape, this is not to be construed as limiting the present invention as other shapes for the frame 48 have been envisioned, such as but not limited to circular, square, triangular and the like. A plurality of rollers 50, arranged in three rows, is rollably supported inside the frame 48 and projects slightly above the frame 48. The rollers 50 are arranged with their axes of rotation transverse to the tracks 32, 40.

The planar top component 22 is slidably supported on the rollers 50 and can thus also slide in the direction of arrow 46. The planar top component 22 may also slide in a direction opposite of arrow 46 as rollers 50 are free to rotate clockwise as well as counter-clockwise.

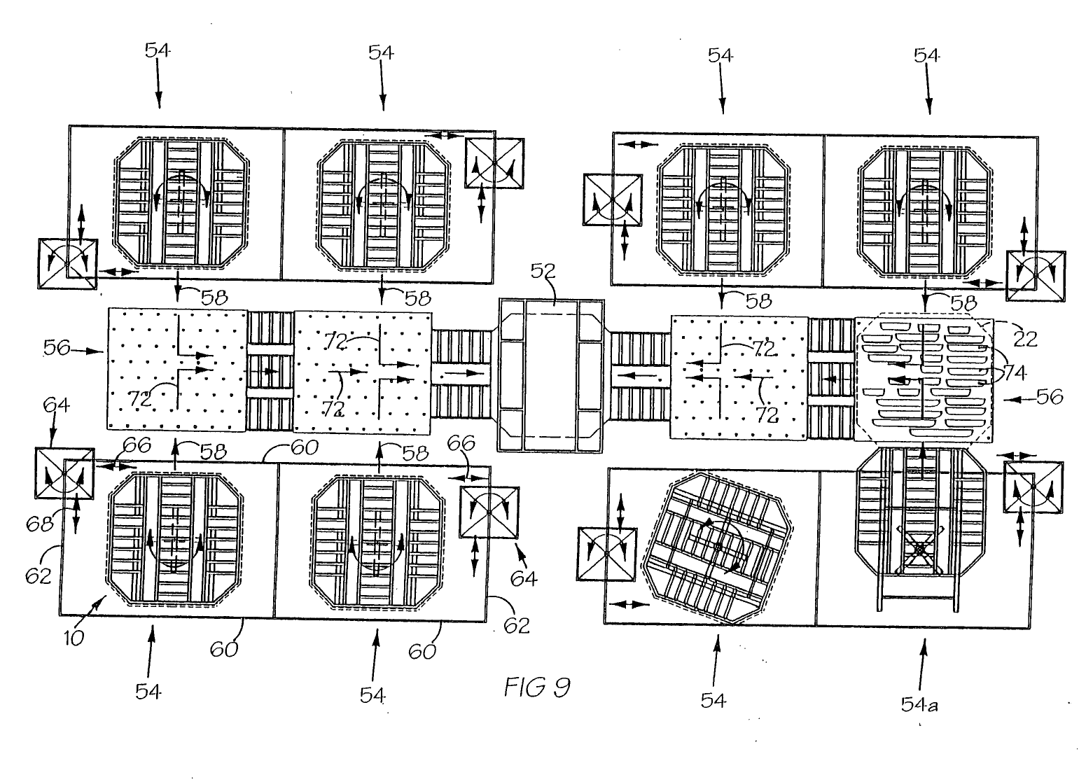

With reference to FIGS. 5-9, the sheet material cutting table 10 may be used to service an incremental cutting press 52 and forms part of a sheet material cutting station 54. Eight sheet material cutting stations 54 are illustrated in FIG. 9. The cutting press 52 is provided with a ball and roller conveyor 56 on two sides. Each conveyor 56 is serviced by four of the sheet material cutting stations 54. The sheet material cutting tables 10 are arranged such that their table tops 18 can slide towards the conveyor 56 as indicated by the arrows 58, to reach the conveyor 56 (see FIGS. 5-7).

Each sheet material cutting station 54 includes a pair of overhead tracks 60. Each pair of tracks 60 supports a beam 62 from which a tool rack 64 is suspended. The beam 62 can travel along the tracks 60 in a direction parallel to the conveyor 56 as indicated by arrows 66. The tool rack 64 is slidably suspended from the beam 62 to be able to travel in the direction of arrow 68. Therefore, the tool rack 64, by means of the tracks 60 and beam 62, is displaceable in an elevated horizontal plane between the tracks 60, as indicated by the arrows 66, 68.

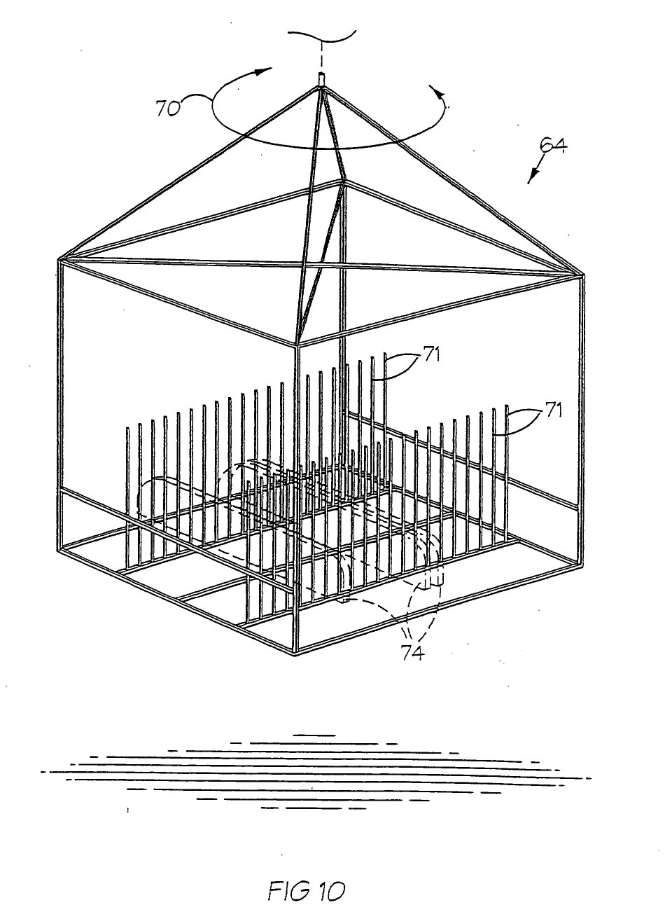

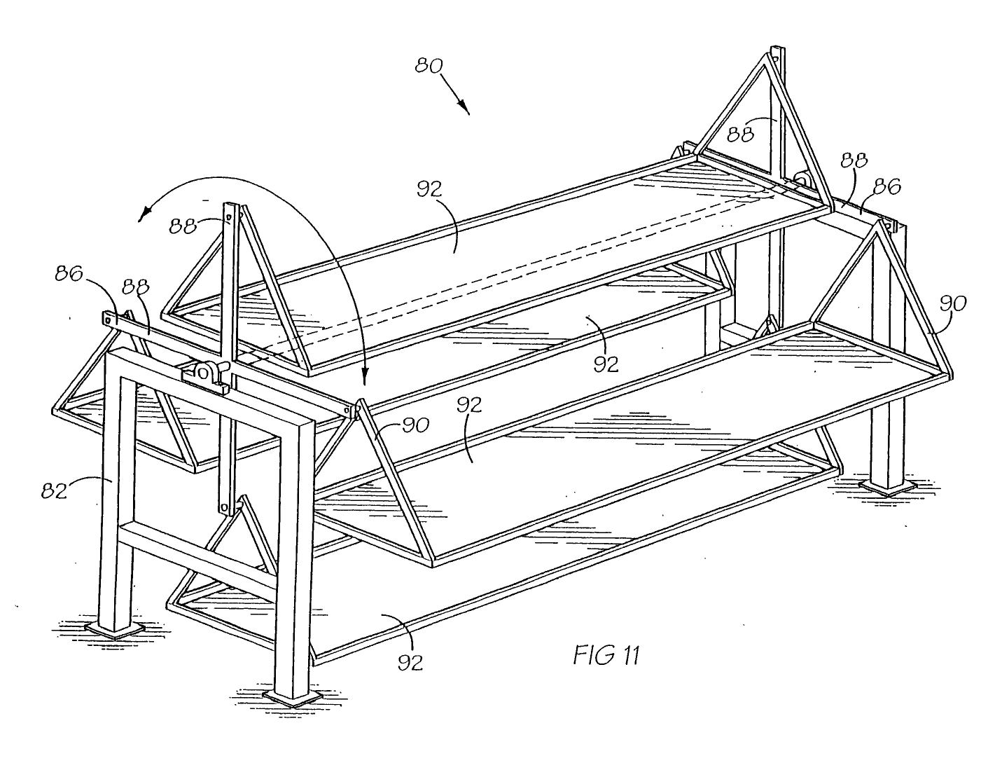

With reference to FIG. 10 and with continuing reference to FIGS. 5-9, the tool rack 64 is rotatably suspended from the beam 62 so that the tool rack 64 can rotate about a substantially vertical axis of rotation, as shown by arrow 70. Each tool rack 64 includes a plurality of cutting die compartments defined by upwardly projecting pins 71. Each compartment can hold a cutting die 74 on its side, as shown in FIG. 10.

In use, a piece of sheet material (not shown) is stretched or thrown open on top of the planar work surface 24 of the planar top component 22. The cutting dies 74, which typically vary in size and shape to correspond with the panels of vehicle upholstery, are arranged on top of the hide to cut desired pieces of leather from the hide. The table top 18 has an outline which falls within a square, circle or another suitable shape. If the table top 18 has an outline which falls within a square, the sides may range from about 1.8 m to about 2.4 m. On the other hand, if the table top 18 has an outline which falls within a circle, the diameter may range from about 2.5 m to 3.4 m. Therefore, as will thus be appreciated, it is not possible for a person standing on one side of the sheet material cutting table 10 to place a die on a portion of the hide near the other side of the sheet material cutting table 10. However, as the table top 18 is rotatable, it is not necessary for the person to walk around the sheet material cutting table 10. Instead, the person can remain stationary and simply rotate the table top 18 to place all of the cutting dies on the sheet material. The sheet material may be any suitable material such as leather, fabric, textile material or the like. More particularly, the sheet material may be automotive leather.

The cutting dies 74 are removed from the tool rack 64 and placed on the sheet material. As the tool rack 64 is rotatable about a vertical axis of rotation, and displaceable to any position in the immediate vicinity of the sheet material cutting table 10, placement of the cutting dies 74 is facilitated. As a result of the tool rack 64 and the rotatable sheet material cutting table 10, far less walking is required to place the cutting dies 74 on the sheet material allowing the cutting dies 74 to be placed much quicker compared to a conventional apparatus.

Once all of the required cutting dies 74 have been placed on the sheet material, the table top 18 is rotated such that it can be slid in the direction of the arrow 58 (see FIG. 9) and the table top 18 is slidably displaced to be closer to the conveyor 56. This situation is illustrated by the leather cutting station 54a in FIG. 9 and in FIG. 6.

The planar top component 22 is then slidably pulled or pushed from the support formation 20 and onto the conveyor 56, from where it is moved by hand into the cutting press 52, as shown by arrows 72. The support formation 20 and the conveyor 56 are at the same height. After the cutting press 52 has been operated to press down on the cutting dies 74 to cut the leather pieces, the planar top component 22 is removed from the cutting press 52, moved again by hand over the conveyor 56 and slid onto the support formation 20. The table top 18 is then pushed or pulled away from the conveyor 56, as shown in FIG. 8, to be centrally located over its base 12. The cutting dies 74 are then removed from the top component 22 and replaced in the tool rack 64 and the leather pieces are removed and placed on an inspection table 80. Thereafter, the process is repeated for the next piece of sheet material.

With reference to FIG. 11, each sheet material cutting station 54 also includes an inspection table 80 to inspect cut pieces of the sheet material. The inspection table 80 comprises a framework 82. Two cross-pieces 86 are rotatably supported by the framework 82. Each cross-piece 86 comprises a pair of beams 88 arranged at perpendicular angles. At the free ends of each beam 88, a triangular suspension formation 90 is rotatably attached. Between corresponding suspension formations 90 on the two cross-pieces 86, a table top 92 is supported.

By rotating the cross-pieces 86 about a horizontally extending axis of rotation, the four table tops 92 are presented one after the other into a position on which objects on the table tops 92 can easily be placed or inspected. Rotation is easily effected by hand.

The invention will now be described by the following example. The example is intended to be illustrative only and is not intended to limit the scope of the invention.

### EXAMPLE

Tests have determined that a two-man team is capable of providing 130 m² of cut leather at a yield of 66.4% using a conventional non-rotatable leather cutting table and a stationary tool rack during a 7.5 hour shift. By using the rotatable sheet material cutting table 10 and the displaceable tool rack 64 of the present invention, as illustrated, the two-man team can provide 170 m² of cut leather at a yield of 66.59% during a normal 7.5 hour shift. In addition, by not having the table top square or rectangular, by having the displaceable tool rack and by using the inspection table 80, as illustrated, it is possible to save up to about 33% in work space required for each leather cutting station.

Although the invention has been described in detail for the purpose of illustration based on what is currently considered to be the most practical and preferred embodiments, it is to be understood that such detail is solely for that purpose and that the invention is not limited to the disclosed embodiments, but, on the contrary, is intended to cover modifications and equivalent arrangements that are within the spirit and scope of the appended claims. For example, it is to be understood that the present invention contemplates that, to the extent possible, one or more features of any embodiment can be combined with one or more features of any other embodiment.

The invention claimed is:

1. A sheet material cutting table comprising:
a base comprising a foot component and a turntable component; and
a table top rotatably supported on the base to rotate about a generally vertical axis, the table top comprising a support formation and a planar top component defining a planar work surface,
wherein at least one of the base and the table top has a track and at least one of the other of the base and the table top has rolling elements configured to roll along the track thereby allowing the table top to be linearly displaceable in a horizontal plane relative to the base.

2. The sheet material cutting table of claim 1, wherein the table top rotates in one of a clockwise and a counter-clockwise direction.

3. The sheet material cutting table of claim 1, wherein the support formation of the table top comprises a frame that is one of circular and polygonal.

4. The sheet material cutting table of claim 3, wherein the frame of the support formation of the table top is polygonal with more than four corners.

5. The sheet material cutting table of claim 4, wherein the frame of the support formation of the table top is hexagonal.

6. The sheet material cutting table of claim 3, wherein the frame of the support formation of the table top includes a plurality of rollers rollably supported therein to slidably support the planar top component.

7. The sheet material cutting table of claim 1, wherein the support formation includes friction-reducing elements to assist in sliding the top component onto or off the support formation.

8. The sheet material cutting table of claim 1, wherein the turntable component of the base is rotatably mounted on the foot component of the base.

9. The sheet material cutting table of claim 1, wherein the sheet material is leather.

10. A sheet material cutting station comprising:
a sheet material cutting table comprising:
a base comprising a foot component and a turntable component; and
a table top rotatably supported on the base to rotate about a generally vertical axis, the table top comprising a support formation and a planar top component defining a planar work surface,
wherein at least one of the base and the table top has a track and at least one of the other of the base and the table top has rolling elements configured to roll along the track thereby allowing the table top to be linearly displaceable in a horizontal plane relative to the base;
an overhead support positioned above the sheet material cutting table; and
a tool rack suspended from the overhead support.

11. The sheet material cutting station of claim 10, wherein the tool rack comprises a plurality of cutting die compartments defined by upwardly projecting pins.

12. The sheet material cutting station of claim 11, wherein the die compartments are configured to hold a cutting die on its side.

13. The sheet material cutting station of claim 10, wherein the overhead support is configured to allow displacement of the tool rack in an elevated, horizontal plane, in two perpendicular directions.

14. The sheet material cutting station of claim 13, wherein the overhead support displaces the tool rack over an area that is larger than an area of the sheet material cutting table.

15. The sheet material cutting station of claim 13, wherein the overhead support allows the tool rack to rotate about a generally vertical axis of rotation.

16. The sheet material cutting station of claim 10, further comprising an inspection table to inspect cut pieces of sheet material.

17. The sheet material cutting station of claim 10, wherein the sheet material is leather.

18. A method of cutting a sheet material comprising:
providing a sheet material cutting table comprising:
a base comprising a foot component and a turntable component; and
a table top rotatably supported on the base to rotate about a generally vertical axis, the table top comprising a support formation and a planar top component defining a planar work surface,
wherein at least one of the base and the table top has a track and at least one of the other of the base and the table top has rolling elements configured to roll along the track thereby allowing the table top to be linearly displaceable in a horizontal plane relative to the base;
placing a piece of sheet material on top of the planar work surface of the planar top component;
removing at least one cutting die from a tool rack suspended from an overhead support, the overhead support positioned above the sheet material cutting table;
placing the at least one cutting die on the piece of sheet material;
slidably pulling the planar top component from the support formation and into a cutting press; and
pressing down on the at least one cutting die by the cutting press to cut the sheet material.

19. The method of claim 18, wherein the sheet material is leather.

20. The method of claim 18, wherein the sheet material is automotive leather.
